(19) United States
(12) Patent Application Publication
(10) Pub. No.: US 2003/0208539 A1
(43) Pub. Date: Nov. 6, 2003

(54) Event-driven information publication

(76) Inventors: Ilya G. Gildenblat, New York, NY (US); Bruce Marcus, New York, NY (US); Sean Moring, Jersey City, NJ (US)

Correspondence Address: ROTHWELL, FIGG, ERNST & MANBECK, P.C., 1425 K STREET, N.W., SUITE 800, WASHINGTON, DC, 20005, US

(21) Appl. No.: 10/136,361

(22) Filed: May 2, 2002

(51) Int. Cl. G06F 15/16

(52) U.S. Cl. 709/205; 709/203

(57) ABSTRACT

An event-driven information publication system includes one or more digital computer networks and one or more nodes on the one or more digital computer networks. A node executes an information publication system application or applet. The node is capable of subscribing to one or more information item categories and receiving an information item that was published according to the one or more information item categories. The information publication system application processes the information item for display.

### BACKGROUND OF THE INVENTION

1. Field of the Invention

The present invention relates generally to an information publication system, and more particularly to an event-driven information publication system.

2. Description of the Background Art

Electronic information publication systems are used to publish digital information items to a plurality of subscribers. Information publication systems may provide information items to multiple, physically separate computerized devices over one or more digital computer networks. The information items may include, for example, stock quotes, financial data, weather reports, news items, etc. The information publication system therefore may be used to disseminate information from a variety of electronic content providers. Such information publication systems provide relatively fast dissemination of new information items over paper publishing, and may conveniently provide information directly to the user (such as on the user's computer or computerized device).

In the prior art there are several approaches to electronic information publication systems. One approach is a “pull” system wherein a subscriber's computer device periodically requests or pulls information items from one or more sources. The user is not directly or immediately provided with information. The prior art pull system typically employs a centralized information warehouse that gathers information for pulling by subscribers.

Pull type information publication systems have several drawbacks. The greatest drawback is that a pull system is incapable of providing real-time information, unless the pull requests are very closely spaced. However, closely spaced requests by subscribers may quickly overwhelm a central server providing the information. Another drawback is that pull information systems may require a significant amount of software to be installed on each user's computer device. Moreover, prior art pull systems require a lot of processing time in each user's machine, as the user's machine must periodically send out an information request. The central server consequently must be equipped to handle a large amount of request traffic.

A second prior art approach is an event-driven or “push” system. An event-driven publish-subscribe system operates by maintaining lists of subscribers and lists of what information item categories each subscriber wishes to receive. Therefore, when a new information item is received, it is sent to all subscribers that have subscribed to the information category pertaining to the new information item.

The event-driven system according to the prior art has several drawbacks. The construction of a prior art event-driven system typically includes a central server (or servers), wherein the server receives information items to be disseminated and looks up each subscriber's information item categories. The server processes the information items to be sent to each subscriber, with the processing performing some manner of manipulating and formatting in order to accommodate the particular subscriber's network communication protocol, hardware platform, software platform, etc. The server then transmits the processed data to the appropriate subscribers. Therefore, in a prior art information system the subscriber's computer merely displays the received information items. The construction of the prior art event-driven system is fairly costly and involves a lot of specialized equipment, including a centralized server, and may include special user hardware, special data transmission lines, special user software, etc.

Another drawback of the prior art event-driven approach is the processing overhead required. In the prior art system, almost all processing is done in the server. The processing is therefore a significant system bottleneck. Moreover, the concentration of processing presents a reliability issue. If there is only a single central server, it may become a single point of failure.

Another drawback is the existence of latency (i.e., delay) due to the processing required of the central server. Because of the latency, there is a delay between receipt of a new information item from an electronic publisher and subsequent publication to all subscribers. In addition, the first subscriber on a massive list receives information updates much faster than the last subscriber on a list. For some types of information items, such as stock market data and other financial data, a delay of even mere seconds may be critical. The latency may be exacerbated by highly diverse subscribers and can rise steeply with increases in the number of subscribers, as well as with an increase in information items each subscriber chooses to receive. This processing bottleneck may be compounded if subscribers are not uniform and are using a variety of networks, hardware platforms, and software platforms (i.e., they require much processing, and varying types of processing between subscribers).

Yet another drawback to a prior art event-driven approach is the cost. Based on the construction of prior art information systems, the subscriber may be required to buy special hardware, such as dedicated communication lines, specific or custom computers, and/or specific software packages. The resulting system may be complex to implement and operate. The subscriber may pay a high subscription cost and potentially expensive maintenance and upkeep costs.

Yet another drawback of the prior art event-driven approach is scalability. The central server concept of the prior art requires a large amount of additional memory and additional processing capability for even moderate expansion in the number of subscribers. The cost of new communication lines, hardware, and software may result in reluctance on the part of potential subscribers to sign up. The cost may also keep subscribers connected in order to justify the initial costs of the prior art event-driven system. The result may be an information system that is maintained within an organization but is not accepted and used outside of a group or organization.

### SUMMARY OF THE INVENTION

An event-driven information publication system according to one embodiment of the invention comprises at least one digital computer network and at least one node on the digital computer network. A node executes an information publication system application or applet. The node is capable of subscribing to one or more information item categories and receiving an information item that was published according to the one or more information item categories. The information publication system applet processes the information item for display. Therefore, the processing is removed from a publisher and is distributed to each subscriber.

A significant benefit is achieved for all components of the information publication system by shifting the processing burden to each subscriber. The result is a small increase in processing workload for each subscriber and a large decrease in processing workload for the publisher. Consequently, publication latency is greatly decreased and publication becomes substantially instantaneous.

The above and other features and advantages of the present invention will be further understood from the following description of the preferred embodiments thereof, taken in conjunction with the accompanying drawings.

### BRIEF DESCRIPTION OF THE DRAWINGS

FIG. 1 shows an information publication system according to one embodiment of the invention;

FIG. 2 is a block diagram of a node configured to act as a publisher;

FIG. 3 is a block diagram of a node configured to act as a subscriber;

FIG. 4 is a flowchart of an information publication method according to another embodiment of the invention;

FIG. 5 is a flowchart of an information publication method according to yet another embodiment of the invention;

FIG. 6 is a flowchart of an information publication method according to yet another embodiment of the invention; and

FIG. 7 is a flow diagram of a multiple publication system that shows parallel publication of an information item.

### DETAILED DESCRIPTION OF THE PREFERRED EMBODIMENTS

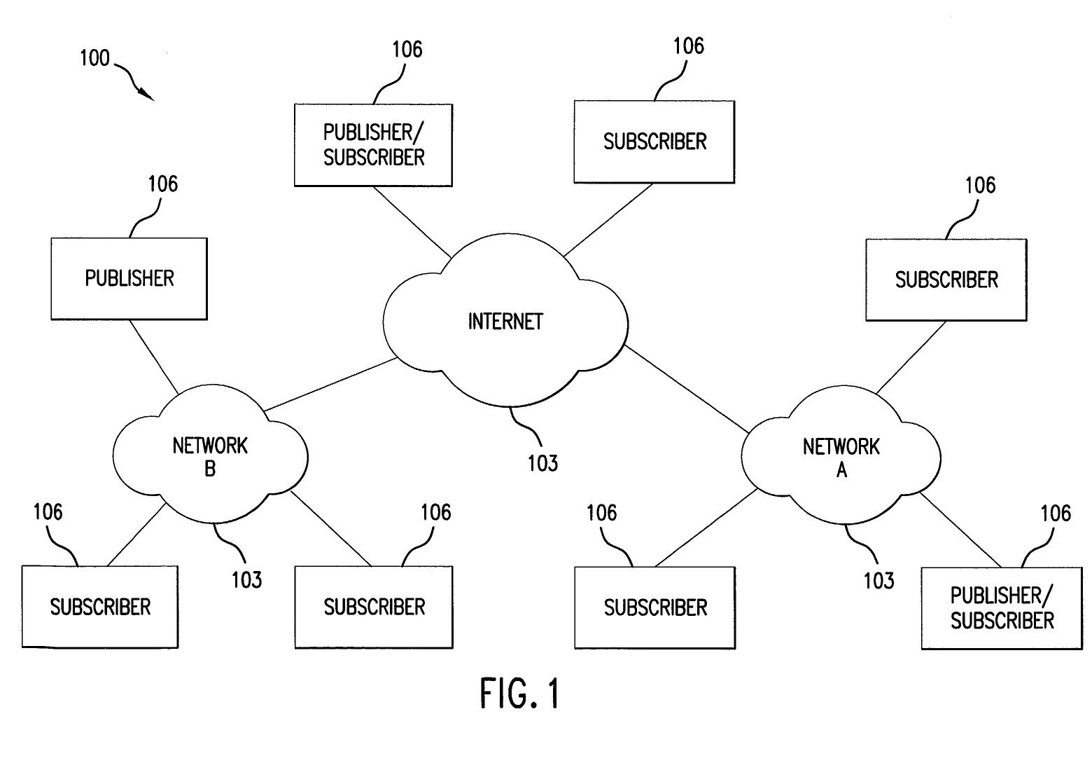

FIG. 1 shows an event-driven information publication system 100 according to one embodiment of the invention. The information publication system 100 may include one or more digital computer networks 103 and one or more nodes 106. The nodes 106 may be components of various computer networks 103, including interconnected networks as shown.

A computer network 103 according to the invention may be any manner of digital computer network, such as a local area network (LAN), a wide area network (WAN), a virtual private network (VPN), the Internet, etc. Although a network 103 may be any type of digital computer network, in one embodiment network 103 is capable of communicating using the TCP/IP digital communication protocol.

A node 106, as used herein, describes any computer or computerized device that is capable of transmitting and receiving digital data over a digital computer network 103. For example, a node 106 may be a personal computer (PC), a laptop or notebook computer, a network workstation, a personal digital assistant (PDA), a pager, a text and/or graphics capable cell phone, etc. The communication may be with any other node 106 within a common network or may be communication with a node of a remote but interconnected network.

A publisher is a node capable of sending (i.e., publishing) information, while a subscriber is a node capable of receiving information. A node 106 may act as an information item publisher, an information item subscriber, or both.

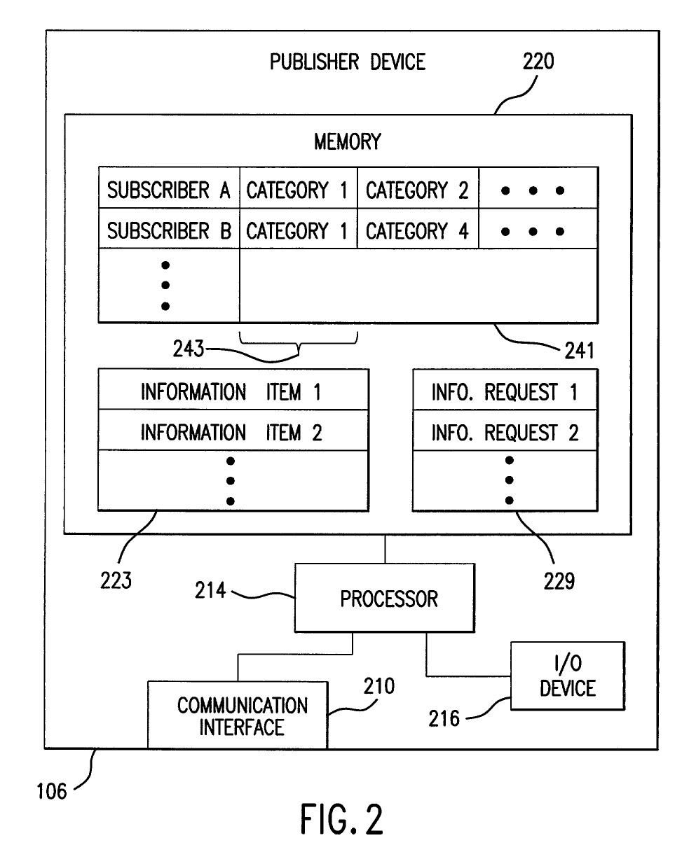

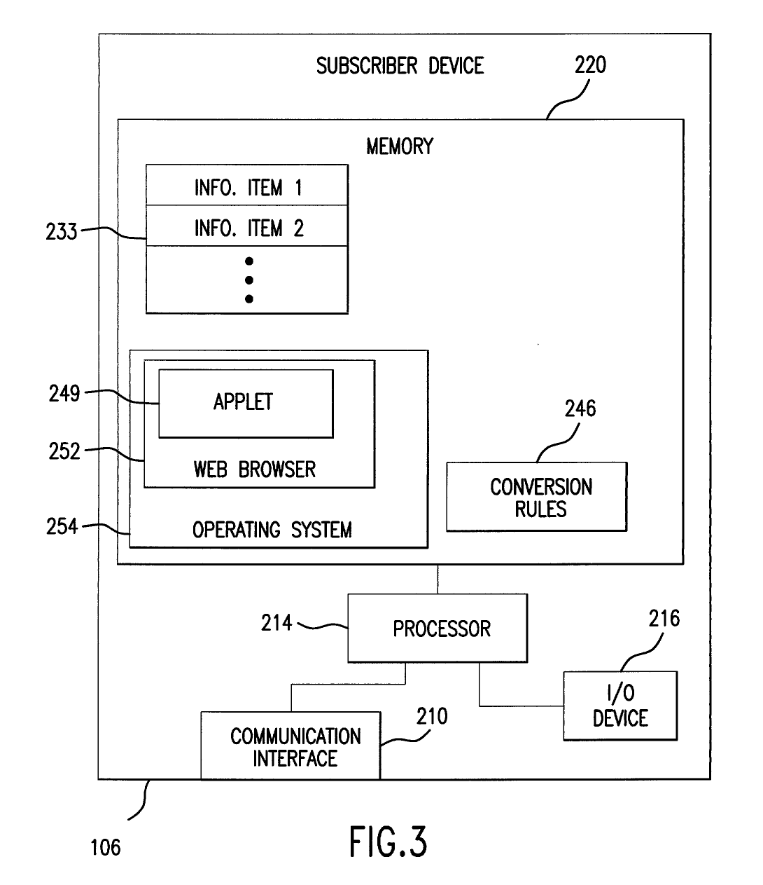

A node 106 acting as a subscriber (see FIG. 3 and accompanying discussion) may receive filtered information items from a node 106 acting as a publisher (see FIG. 2 and accompanying discussion). In an additional capability, a node 106 acting as a subscriber may additionally process and/or republish information and also act as a publisher.

As shown in FIG. 3, the node 106 acting as a subscriber may include an information publishing system applet 249 that processes received information items for display. This may include processing that enables received information items to be displayed to a user. The processing may include data translation, data formatting, window sizing and placement, selection of information items to be concealed or displayed, etc. This presents the advantage that the information items may be published in an essentially unprocessed state. The term unprocessed means not processed to accommodate the particular receiving node 106, as the information item may have been previously processed in some manner. The information items may be published in a format such as in binary, ASCII, delimited ASCII, text, XML, Unicode, or as image files in any known image format, video files in any known video format, audio files in any known audio format, etc.

The substantially raw, unprocessed state of published information items relieves the publisher of the burden of: 1) tracking formats needed by each subscriber, 2) processing each information item to be published, and more specifically, 3) processing each information item to be published according to the format needs of each interested subscriber. This is a significant amount of processing to be done by a publisher. In addition, this processing overhead will grow rapidly as the number of subscribers grow in number and as the number of information items to be published grow in number.

FIG. 2 is a block diagram of node 106 configured to act as a publisher. The node 106 may include a communication interface 210, a processor 214, at least one I/O device 216, and a memory 220.

The communication interface 210 may be any type of communication interface capable of communicating over a digital computer network. This may include a computer network card, a computer modem, a computer wireless modem, etc. In one embodiment, the communication interface 210 is a communication interface that supports the TCP/IP communication protocol, such as a communication interface capable of supporting sockets, including JAVA TCP/IP sockets.

The at least one I/O device 216 may be any type of input and/or output device, including a keyboard, a mouse, a pointing device, a cathode ray tube or other type of display, a printer, etc. The at least one I/O device 216 may be employed by a user of the node 106 to create content to be published, to publish content, to subscribe or modify an existing subscription, to manipulate or further process a received information item, etc.

The processor 214 may be any type of general purpose processor. The processor 214 may control overall operations of the node 106 and may additionally control publication of information items.

The memory 220 may be any type of digital memory. The memory 220 may include an information items storage area 223, an information request storage area 229, and a subscriber information storage area 241. In addition, the memory 220 may store a publisher routine for publishing information items to subscribers and one or more operational software routines for operating the node 106.

The information items storage area 223 may store any number of information items to be published. The information items may be received from any previous publisher within the information publication system 100. A previous publisher may be another node 106 acting as a publisher, or may be any source of information items. For example, the publisher may be a composing computer device of which information items are composed, formatted, etc., and wherein any produced information items are then transmitted for publication to the node 106 acting as a publisher.

The information items may be stored in the condition they are received (i.e., in a substantially raw, unprocessed state), or may be processed by the applet 249 before being stored. It should be noted that a node 106 acting as a publisher may be required to publish according to a predetermined standard. For example, it may publish information items that can be encoded within a JAVA Object and transmitted using JAVA's serialization mechanism. Additionally, the node 106 acting as a publisher may publish information items in formats such as ASCII, XML, TEXT, UNICODE, binary, various image formats, etc.

It should be noted that the information items storage 223 may not need to be persistent storage. Consequently, if the information items storage 223 is not a persistent storage, an applet may be employed in order to realize a thin client subscriber (and even a publisher). In an optional feature, a publisher may process received information items to make sure that duplicate information items have not been received.

The subscriber information storage 241 may contain a listing of subscribers, such as electronic addresses of subscribers, for example. Each subscriber may be associated with a corresponding list of one or more information item categories 243 that specify categories of information items to be received by the node 106.

The subscriber information request storage 229 may be a storage or accumulation of information item requests from subscribers. Information items requested of the node 106 acting as a publisher may prompt transmission of the requested information item to the requesting subscriber. If the subscriber information request storage 229 performs some manner of request accumulation, the accumulation may minimize duplicate requests, and therefore may minimize communication and processing overhead on the part of the node 106 when acting as a publisher.

It should be understood that a node acting as a publisher does not necessarily have to publish to multiple subscribers. A publisher may publish a single instance of information content to another node that further publishes the information content, including publishing to a plurality of subscribers. This may be an institutional feature wherein one particular node receives and publishes information items from all employees within the institution in order to simplify the publication process.

It should be understood that a publisher node 106 may or may not perform error checking. A publisher node 106 may not perform any checking aimed at insuring that subscribers successfully received published information items. It is the responsibility of the subscriber node to ensure that the relevant information is received. If the relevant information is not successfully or completely received, a subscriber node may request the desired information. This capability allows a publisher node to push more processing tasks onto the subscriber nodes, thereby providing for more scalable and cost efficient subscriber machines.

FIG. 3 is a block diagram of a node 106 configured to act as a subscriber. The node 106 may include a communication interface 210, a processor 214, at least one I/O device 216, and a memory 220. All components in common share the reference numerals of FIG. 2, and are discussed above. It should be noted that although the node acting as a publisher and the node acting as a subscriber are separately discussed, a single node 106 may act as both and therefore may include all elements.

The memory 220 may be any type of digital memory. The memory 220 in a node 106 acting as a subscriber may include an information item storage area 233, a set of conversion rules 246, an information publication system applet 249, a web browser 252, and an operating system 254.

The information items storage area 233 may store received information items. As before, the information items storage area 233 may be a persistent storage. If it is not a persistent storage, the node 106 acting as a subscriber may display a received information item until the user de-selects that particular display, upon which time the information item may be lost. Alternatively, a user may be able to configure the node 106 to store any received information items until manually deleted.

The information publication system applet 249 is a computer program designed to be executed from within another application, i.e., from within the web browser 252. In addition to an applet, the publication system may be a full-fledged application. For purposes of explanation only, the system hereinafter will be described in terms of an applet. As used hereinafter, the term “applet” is intended to be encompassed within the more general term “application.” The web browser 252 in turn operates within the operating system 254.

Only one applet 249 may be required for subscriber node operation, regardless of the operating system. For example, a JAVA applet can run on any operating system without modification.

The information publication system applet 249 according to the invention is a customized applet that can receive information items in a raw, unprocessed and/or unformatted state, or in a partially processed state, and that processes the information items for display and/or storage within the node 106.

It should be noted that although the information could be preprocessed by the publisher node publishing the information, a significant benefit is achieved for all components of the information publication system 100 by shifting the processing burden to each subscriber. According to the invention, the processing is removed from a publisher and is distributed to each subscriber. The result is a small increase in processing workload for each subscriber and a large decrease in processing workload for the publisher. Consequently, publication latency is greatly decreased and publication becomes substantially instantaneous. This is significant because even a small improvement in latency yields important and needed improvements in publication systems that deliver real-time information.

The applet 249 may format the data for presentation within a standard template. The processing and/or formatting may be specific to the subscriber's hardware and software platforms. Therefore, depending on the hardware and software employed by the node 106, the applet 249 may be selected and installed in order to properly process the received information items. For example, a particular applet will be selected depending on whether the subscriber's operating system 254 is WINDOWS, LINUX, etc. This is typically done automatically without the need for user intervention.

In addition to accommodating the basic system hardware and software requirements, the information publication system applet 249 may perform other processing that is specific to user selections and customizations. As a result, the processing performed by the applet 249 may include filters for specific content. Furthermore, the processing may achieve predetermined “look and feel” parameters.

User customization may be achieved through the use of the extensible Stylesheet Language (XSL). The XSL language may be used to separate style from content when creating HTML or XML pages. The XSL specifications work much like templates, allowing designers to create a uniform appearance when displaying multiple pages. The XSL style sheet may be configured according to known user preferences, and may be customizable according to user preferences.

In one embodiment, all received content may ultimately be converted by the information publication system applet 249 into a hypertext mark-up language (HTML) format regardless of the original format of the received information items. For example, the received information items may first be processed into an XML format, transformed according to XSL stylesheets, and then converted into HTML format for display.

An applet 249 in a node 106 acting as a subscriber may send information back to a publisher in some circumstances. For example, the applet 249 may send error messages, may send requests for additional and/or specific information, may re-publish information aimed at other users (e.g., in the case a particular user wishes to notify peers of some information), or may send customization requests regarding the content or format of the information items. In addition, other information items may be transmitted from the subscriber to the publisher as desired.

The set of conversion rules 246 may be a set of processing and/or formatting rules for the subscriber. The applet 249 may access the set of conversion rules 246 in order to receive and process one or more information items. The set of conversion rules 246 may be platform dependent and may be usersettable. Therefore, the set of conversion rules 246 may reflect the particular preferences of the user. The set of conversion rules 246 may be updatable and/or upgradable in order to adjust the applet 249 if the configuration of the node 106 (as a subscriber) is changed.

When a subscriber goes offline, the publisher simply stops sending information to the subscriber. The online or offline status of a subscriber may not be checked by a publisher node 106. It is the responsibility of the subscriber (when it comes online) to register appropriate interests with all relevant publishers. This may be done by sending a remote register event to all relevant publishers, indicating contents of interest (i.e., re-subscribing whenever connecting to a corresponding computer network).

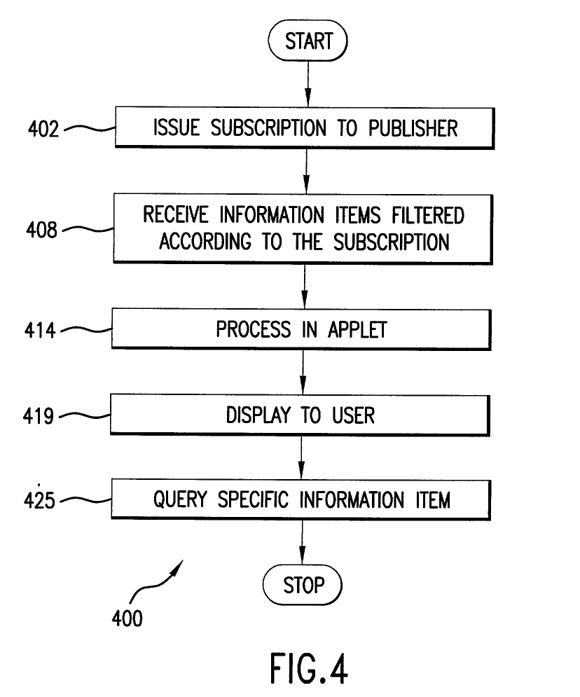

FIG. 4 is a flowchart 400 of an event-driven information publication method according to another embodiment of the invention. In step 402, a node 106 acting as a subscriber issues a subscription to one or more publishers. The subscription may list what information item categories the node 106 is interested in receiving. The categories may be default categories loaded when the information publication system applet 249 is first loaded, or may be categories selected by a user or users of the node 106.

In step 408, the node 106 receives published information items that have been filtered according to the subscription. Consequently, a publisher which obtains an information item to be published that falls within the subscription given by a particular node 106 publishes the information item to the particular node 106.

In step 414, the received information item is processed by the information publication system applet 249. The processing may include any manner of data translation, data organization, data presentation, etc., as previously discussed.

In step 419, the processed information item is displayed to the user. If the information item is stock market data, for example, the information item may be displayed in a window on a computer display screen. Alternatively, the information item may be printed out or displayed in some other manner.

In step 425, the node may query a specific information item from publishers. For example, in the case of stock data, the user may query a particular company name or stock ticker symbol. The response may comprise information items received from one or more publisher nodes. It should be noted that such a query may be issued at any time.

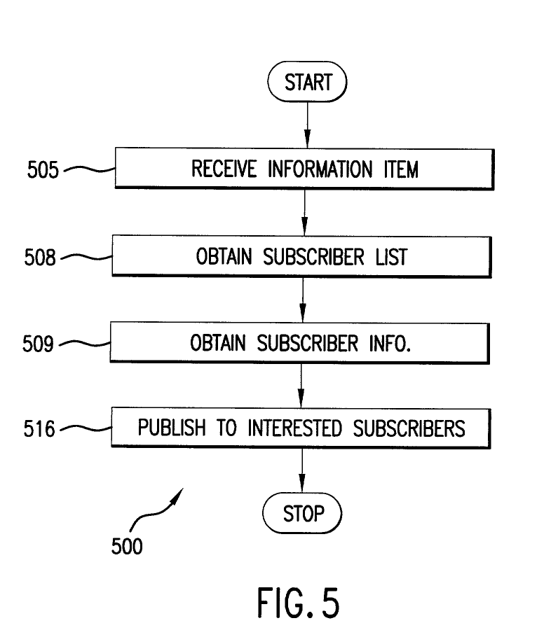

FIG. 5 is a flowchart 500 of an event-driven information publication method according to yet another embodiment of the invention. In step 505, a node 106 acting as a publisher receives an information item to be published. The information item may have been previously processed or may be substantially raw and unprocessed. The information item may be received from another node acting as a publisher or from any information item composer, including non-nodes, as previously discussed.

In step 508, the publisher node 106 obtains a list of subscribers. The subscribers are nodes 106 that have submitted a subscription that includes information item categories to be received.

In step 509, the publisher node 106 obtains subscriber information for all interested subscribers. This may include obtaining all subscribers who have an information item category that includes the current information item to be published.

In step 516, the publisher node 106 publishes the information item to all interested subscriber nodes 106. The subscribers process the received information items using stored applets or applications, and the processed information items are displayed to the actual subscribers.

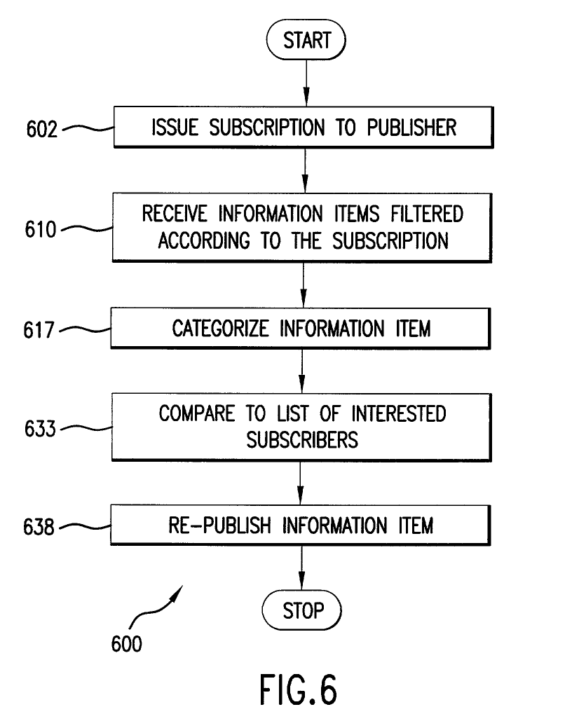

FIG. 6 is a flowchart 600 of an information publication method according to yet another embodiment of the invention. The information publication method 600 may be performed by any node 106 capable of acting as both a subscriber and a publisher.

In step 602, a node 106 acting as a subscriber may issue a subscription to one or more nodes 106 acting as a publisher. This subscription may list what information item categories the node 106 is interested in receiving, as previously discussed.

In step 610, the node 106 receives an information item (or items) filtered according to the subscription. The information item may be received at any time after the subscription.

In step 617, the received information item may be categorized, i.e., classified according to an information item category. This is done so that the receiving subscriber node may tell what category the information item falls into. This step is only necessary if the node 106 is re-publishing the information item.

In step 633, the information item category for the received information item is compared to a list of interested subscribers. A match is found between the information item category of the received information item to those of subscribers.

In step 638, the received information item is republished to all interested subscribers. The node 106 therefore acts as a subscriber and a publisher, and may not only receive an information item but may pass it on to one or more other nodes. It should be noted that a node 106 that receives and republishes an information item does not need to process the information item. However, the node 106 may concurrently process it for display.

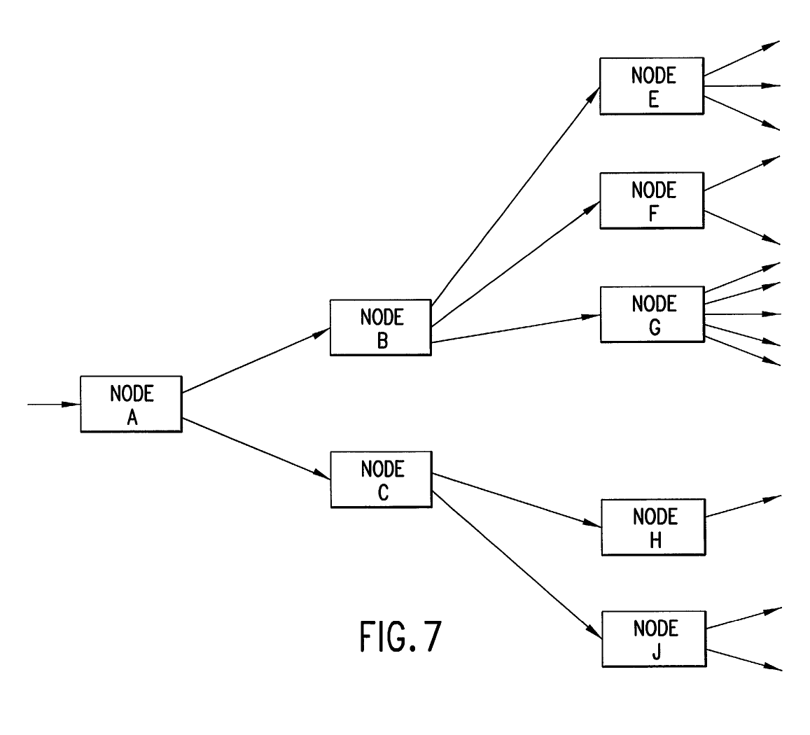

FIG. 7 is a flow diagram of a multiple publication system that shows parallel publication of an information item. In the diagram, a received information item (represented by the arrow going into node A on the left edge of the Figure) is republished by node A to both node B and node C. In addition, Node B and node C may subsequently republish the information item, such as to node E, node F, node G, node H, and node J. Each of these subsequent nodes may republish the information item, in addition to retaining and displaying the information item. Therefore, the publication of an information item may be a sequential relay process, wherein multiple nodes are used to distribute an information item without any significant processing load being placed on any one node.

The event-driven information publication according to the invention provides several benefits. The publication of information items may be protocol independent. For example, in one embodiment, the event-driven information publication system may be designed for any platform supporting Sun's JAVA II Standard Edition (J2SE) virtual machine and capable of conducting socket communications over TCP/IP capable networks. In addition, the invention may be hardware independent, with the only hardware dependency being a selection of an appropriate applet 249 to be loaded on to a node 106.

The benefits provided to a publisher are less processing overhead, less delivery latency, and no need for a publisher node to be designed to accommodate the subscriber's network hardware, software, etc. In addition, the publisher node does not have to be designed to accommodate any intervening networks.

An additional benefit is that the event-driven system according to the invention dramatically reduces the complexity of publishers by being able to layer the publishers. For example, publisher B may rely on content from publisher A to create new content. Another benefit is that a publisher need only receive information items for publication, filter the information items for proper recipients, and transmit to proper recipients in the form of essentially raw data.

At the subscriber end, a subscriber is inexpensive and easy to implement. A subscriber may also be a publisher. An applet within the subscriber node processes the raw information items and presents them to the user in a display appropriate to the user's computer environment. Therefore, a subscriber node may accommodate any network of the user, may accommodate any hardware platform of the user, and may accommodate any software platform of the user. This is easily and conveniently accomplished through selection of an appropriate applet. In addition, the subscriber node is thin client capable, as no information persistence on the subscriber is required. Moreover, a user may subscribe and/or unsubscribe without having to purchase special equipment or software.

While the invention has been described in detail above, the invention is not intended to be limited to the specific embodiments as described. It is evident that those skilled in the art may now make numerous uses and modifications of and departures from the specific embodiments described herein without departing from the inventive concepts.

What is claimed is:

1. An event-driven information publication system, comprising:
at least one digital computer network capable of communicating digital data; and
at least one node on said digital computer network, said node executing an information publication system application and being capable of subscribing to at least one information item category and receiving an information item that was published according to said information item category, said information publication system application processing said information item for display on said node.

2. The system of claim 1, wherein a node acting as a subscriber receives said published information item in a substantially unprocessed state.

3. The system of claim 1, wherein a node comprises a thin client.

4. The system of claim 1, wherein reception of an information item by a particular node is independent of a communication protocol employed by a digital computer network over which said particular node communicates.

5. The system of claim 1, wherein reception of an information item by a particular node is independent of a hardware platform of said particular node.

6. The system of claim 1, wherein reception of an information item by a particular node is independent of a software platform of said particular node.

7. The system of claim 1, wherein a node acting as a subscriber also acts as a publisher.

8. The system of claim 1, wherein said node is further capable of electronically receiving an information item, comparing said received information item to a list of interested subscribers, and publishing said received information item to said interested subscribers.

9. The system of claim 1, wherein a second node acts as a subscribe node and receives a particular information item published by a first node and republishes said particular information item.

10. The system of claim 1, wherein a digital computer network of said one or more digital computer networks employs a TCP/IP network protocol.

11. The system of claim 1, wherein a digital computer network of said one or more digital computer networks comprises the Internet.

12. The system of claim 1, wherein a node acting as a publisher stores a listing of subscribers and stores one or more information item categories for each subscriber.

13. The system of claim 1, with a node acting as a publisher further comprising an information item request storage area that receives and stores information item requests from subscribers, and wherein said node acting as a publisher checks said information item request storage area and sends a requested information item to a requesting subscriber.

14. The system of claim 1, wherein said event-driven information publication system publishes information items substantially in real time.

15. The system of claim 1, wherein said node is adapted for use as a publisher node, said node further comprising:
a subscriber information storage area storing a listing of subscribers and storing one or more information item categories for each subscriber;
an information item storage area storing one or more substantially unprocessed information items to be published;
a communication interface capable of communicating over a digital communication network;
a processor communicating with said subscriber information storage area, with said information item storage area, and said communication interface;
wherein said network node, acting as said publisher node, compares a substantially unprocessed information item to be published to said one or more information item categories for said one or more subscribers and publishes said substantially unprocessed information item to one or more interested subscribers.

16. The system of claim 1, wherein said node is adapted for use as a subscriber node, with said node comprising:
an application capable of processing a received information item for display;
a set of conversion rules that specify how to process said received information item;
an information item storage area storing one or more received information items;
a communication interface capable of communicating over a digital communication network;
a processor communicating with said subscriber information storage area, with said information item storage area, and said communication interface;
wherein said network node, acting as said subscriber node, sends a subscription to a publisher, receives substantially unprocessed information items according to said subscription, processes said substantially unprocessed information items in said application for display, and displays said information items.

17. A node adapted for use as a publisher node in an event-driven information publication system, comprising:
a subscriber information storage area storing a listing of subscribers and storing one or more information item categories for each subscriber;
an information item storage area storing one or more substantially unprocessed information items to be published;
a communication interface capable of communicating over a digital communication network; and
a processor communicating with said subscriber information storage area, with said information item storage area, and said communication interface;
wherein said node, acting as said publisher node, compares a substantially unprocessed information item to be published to said one or more information item categories for said one or more subscribers and publishes said substantially unprocessed information item to one or more interested subscribers.

18. The node of claim 17, further comprising an information item request storage area that receives and stores information item requests from subscribers, and wherein said network node checks said information item request storage area and sends a requested information item to a requesting subscriber.

19. The node of claim 17, wherein said communication interface comprises a network card.

20. The node of claim 17, wherein said communication interface comprises a modem.

21. The node of claim 17, wherein said communication interface comprises a wireless modem.

22. The node of claim 17, wherein said information item storage comprises a persistent storage.

23. The node of claim 17, wherein said node publishes an information item in a raw, unprocessed state.

24. The node of claim 17, wherein said node comprises a thin client.

25. The node of claim 17, wherein publication of an information item by said node is independent of a communication protocol employed by a digital computer network over which said node communicates.

26. The node of claim 17, wherein publication of an information item by said node is independent of a hardware platform of subscriber nodes.

27. The node of claim 17, wherein publication of an information item by said node is independent of a software platform of subscriber nodes.

28. The node of claim 17, wherein said node also acts as a subscriber.

29. A node adapted for use as a subscriber node in an event-driven information publication system, comprising:
an application capable of processing a received information item for display;
a set of conversion rules that specify how to process said received information item;
an information item storage area storing one or more received information items;
a communication interface capable of communicating over a digital communication network; and
a processor communicating with said subscriber information storage area, with said information item storage area, and said communication interface;
wherein said node, acting as said subscriber node, sends a subscription to a publisher, receives information items according to said subscription, processes said information items in said application for display, and displays said information items.

30. The node of claim 29, wherein said communication interface comprises a network card.

31. The node of claim 29, wherein said communication interface comprises a modem.

32. The node of claim 29, wherein said communication interface comprises a wireless modem.

33. The node of claim 29, wherein said information item storage comprises a persistent storage.

34. The node of claim 29, wherein said node receives said published information item in a raw, unprocessed state.

35. The node of claim 29, wherein said node comprises a thin client.

36. The node of claim 29, wherein reception of an information item by said node is independent of a communication protocol employed by a digital computer network over which said node communicates.

37. The node of claim 29, wherein reception of an information item by said node is independent of a hardware platform of said node.

38. The node of claim 29, wherein reception of an information item by said node is independent of a software platform of said node.

39. The node of claim 29, wherein said node also acts as a publisher.

40. An event-driven information publication method for publishing an information item between nodes on at least one digital computer network, comprising the steps of:
issuing a subscription from a first network node acting as a subscriber to a second network node acting as a publisher;
receiving an information item in said first network node from said second network node, with said information item being filtered according to said subscription;
processing said information item in an application running in said first network node to create a display-ready information item; and
displaying said display-ready information item on said first network node.

41. An event-driven information publication method for publishing an information item between nodes on at least one digital computer network, comprising the steps of:
issuing a subscription from a first network node acting as a subscriber to a second network node acting as a publisher;
receiving an information item in said first network node from said second network node, with said information item being filtered according to said subscription;
categorizing said information item into an information item category;
comparing said information item category to a list of interested subscribers, with said list of subscribers storing one or more information item categories for each subscriber; and
republishing said information item to interested subscribers.

42. An event-driven information publication method for publishing an information item between nodes on at least one digital computer network, comprising the steps of:
receiving an information item to be published in a first network node;
obtaining a list of subscribers stored in said first network node;
obtaining subscriber information item categories for said list of subscribers, with a subscriber entry of said list of subscribers including one or more information item categories to be received by a corresponding subscriber; and
publishing said information item to all interested subscribers.
